(19) United States
(12) Patent Application Publication
(10) Pub. No.: US 2012/0281143 A1
(43) Pub. Date: Nov. 8, 2012

(54) Numeric Input Using Navigation Keys

(76) Inventors: Jenny Chow, San Diego, CA (US); Manish Gupta, San Diego, CA (US); Steven Friedlander, San Diego, CA (US)

(21) Appl. No.: 13/100,592

(22) Filed: May 4, 2011

(51) Int. Cl. H04N 5/445

(52) U.S. Cl. 348/563; 348/E05.103

(57) ABSTRACT

Characters representing each of numerals zero (0) through nine (9) and a decimal point are assigned to one of four directional navigation keys. Each character is further assigned to a different number of presses of the respective directional navigation key. User navigation, using at least one of the four directional navigation keys, to a numeric input field is detected during a directional navigation input mode. A navigation key input processing mode is changed to a numeric input mode responsive to this detection. At least one press of one of the four directional navigational keys is detected and the character assigned to the detected at least one press is selected. The selected assigned character is sent to the television receiver device to display as input within the numeric input field. This abstract is not to be considered limiting, since other embodiments may deviate from the features described in this abstract.

### COPYRIGHT AND TRADEMARK NOTICE

A portion of the disclosure of this patent document contains material which is subject to copyright protection. The copyright owner has no objection to the facsimile reproduction of the patent document or the patent disclosure, as it appears in the Patent and Trademark Office patent file or records, but otherwise reserves all copyright rights whatsoever. Trademarks are the property of their respective owners.

### BACKGROUND

Remote control devices utilize directional/navigational keys to move from field to field within a user interface of devices, such as televisions. For entry of numeric information, a numeric keypad is provided. A user selects individual numeric keys for each number to be entered.

### BRIEF DESCRIPTION OF THE DRAWINGS

Certain illustrative embodiments illustrating organization and method of operation, together with objects and advantages may be best understood by reference detailed description that follows taken in conjunction with the accompanying drawings in which:

FIG. 1 is a block diagram of an example of an implementation of a system that provides numeric input using navigation keys consistent with certain embodiments of the present invention.

FIG. 2 is a detailed diagram of an example of an implementation of a remote controller device that provides numeric input using navigation keys consistent with certain embodiments of the present invention.

FIG. 3 is a diagram of an example of an implementation of numeric key assignments for the remote controller device that may be used to provide numeric input using navigation keys consistent with certain embodiments of the present invention.

FIG. 4 is a block diagram of an example of an implementation of the remote controller device that provides numeric input using navigation keys consistent with certain embodiments of the present invention.

FIG. 5 is a flow chart of an example of an implementation of a process that provides automated numeric input using navigation keys consistent with certain embodiments of the present invention.

FIG. 6 is a flow chart of another example of an implementation of a process that provides automated numeric input using navigation keys consistent with certain embodiments of the present invention.

### DETAILED DESCRIPTION

While this invention is susceptible of embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings.

The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “program” or “computer program” or similar terms, as used herein, is defined as a sequence of instructions designed for execution on a computer system. A “program,” or “computer program,” may include a subroutine, a function, a procedure, an object method, an object implementation, in an executable application, an applet, a servlet, a source code, an object code, a shared library/dynamic load library and/or other sequence of instructions designed for execution on a computer system having one or more processors.

The term “program,” as used herein, may also be used in a second context (the above definition being for the first context). In the second context, the term is used in the sense of a “television program.” In this context, the term is used to mean any coherent sequence of audio video content such as those which would be interpreted as and reported in an electronic program guide (EPG) as a single television program, without regard for whether the content is a movie, sporting event, segment of a multi-part series, news broadcast, etc. The term may also be interpreted to encompass commercial spots and other program-like content which may not be reported as a program in an electronic program guide.

Reference throughout this document to “one embodiment,” “certain embodiments,” “an embodiment,” “an implementation,” “an example” or similar terms means that a particular feature, structure, or characteristic described in connection with the example is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means “any of the following: A; B; C; A and B; A and C; B and C; A, B and C.” An exception to this definition will occur only when a combination of elements, functions, steps or acts are in some way inherently mutually exclusive.

The present subject matter provides numeric input using navigation keys. The numeric input using navigation keys reduces the form factor for remote control devices, such as television remote control devices, and improves user interface functionality by reducing the number of different remote control keys that a user must use to interact with a consumer electronics device using a remote control. The numeric input using navigation keys described herein may be used to enter a variety of numeric information into numeric input fields of a user interface of a television, such as for example, passwords, access coding, zip codes, channel selections, or any 0-9 numerical input with a remote controller. The navigation key set or direction buttons are provided with additional functionality to eliminate a numeric keypad. During any user interaction where a user interface (UI) screen displays a numerical input field, a user may press the navigation or direction keys, such as for example, in a clock-wise direction to obtain or select numerals to input into the respective input field.

It should be noted that the present subject matter may be implemented in association with television receiver devices. Television receiver devices may include devices, such as for example, a television set, a set-top box (STB), a set back box, a receiver card, or other device for receiving and decoding television signals. The examples herein may utilize the term “television” for ease of reference. However, it is understood that the term “television” may include any television receiver device.

The remote control device may be considered to have two navigation key input processing modes associated with four directional navigation keys. The first navigation key input processing mode may be considered a directional navigation input mode where key presses of navigation keys result in instructions to the television to navigation within a user interface of the television. The second navigation key input processing mode may be considered a numeric input mode that results in key presses of the four directional navigation keys to result in numeric character entry into numeric input fields of the television user interface, such as the example numeric input fields described above.

In the numeric input mode, characters representing each of numerals zero (0) through nine (9) and a decimal point are assigned to one of four directional navigation keys. Each character assigned to each respective directional navigation key is further assigned to a different number of presses of the respective directional navigation key. Assigning characters representing each of numerals zero (0) through nine (9) and the decimal point to one of the four directional navigation keys may include iteratively/sequentially assigning the characters clockwise from a first one of the four directional navigation keys until each key is assigned to one of the four directional navigation keys.

The remote control device detects user navigation, using at least one of the directional navigation keys, to a numeric input field during a directional navigation input mode. The directional navigation input mode may then be changed to a numeric input mode responsive to detection of the user navigation to the numeric input field. One or more presses of one of the four directional navigational keys may then be detected and a numeric or decimal character assigned to the detected number of presses of the respective directional navigation key(s) may be selected and sent to the television as input within the numeric input field. The remote control device may iteratively detect further presses of the same or different directional navigational keys and may select and send the characters assigned to the further selections to the television as input within the numeric input field.

The numeric input mode may further be refined to include a multiple character numeric input mode and a single character numeric input mode. Within the multiple character numeric input mode, the remote control device sends each assigned character for each press of each directional navigation key to the television for population within the numeric input field. Further, the remote control device may send each character assigned to each sequential key press to the television for display in response to each key press to provide user feedback so that the user may select the desired numeric character for entry. A timer may be utilized to measure inter-key press time thresholds and may send an instruction to the television to finalize input for a current numeric character position using a last sent assigned character and move a numeric entry prompt to a new numeric character position in response to expiration of the inter-key press time threshold.

Within the single character numeric input mode, the remote control device filters multiple key presses of a given directional navigation key and sends a single character to the television for processing in response to detection of completion of numeric character selection using the respective directional navigation key. The remote control device may determine a quantity of presses and select the character assigned to the detected quantity of presses of the one of the four directional navigational keys. Inter-press key timing may be measured and examined to determine when to select the character assigned to the accumulated quantity of key presses to send to the television. Further, the inter-press key timing may be learned by the remote control device. For example, certain users may enter numbers within the single numeric input character mode either slower or faster than other users. The remote control device may learn an inter-press key timing and detect a deviation in that timing (e.g., a delay after one or more key presses). The remote control device may then consider the character assigned to the last detected quantity of presses as the selected character. Within the single character numeric input mode, the remote control device may send the single character for each numeric input position to the television for numeric input rather than sending each character. Further, users may memorize key press combinations of directional navigation keys, and entry speed of numeric information may be increased along with a reduction in numeric key information being sent to the television.

Within either numeric input mode, the remote control device may detect at least one press of a different one of the four directional navigational keys and may determine that numeric character selection is completed for the previous directional navigation key. In response to such a determination, the remote control device may send an instruction to the television to finalize input for a current numeric character position using a last sent assigned character (for the multiple character numeric input mode) or may send the character assigned to the last determined quantity of key presses (for the single character numeric input mode) and instruct the television to finalize entry for a given numeric character position. The remote control device may further instruct the television to move a numeric entry prompt to a new numeric character position. The remote control device may then begin processing assigned characters for the new numeric character position, again based upon the processing associated with the respective numeric input mode as described above and in more detail below.

The remote control device may detect user selection of a select key function and change the numeric input mode to the directional navigation input mode for further navigation within the user interface of the television. The remote control device may further instruct the television to process the displayed character(s) within a numeric input field. As described in more detail below, the select key function may be integrated with the four directional navigational keys within a single mechanical key with different key contacts for each of the select key and the four directional navigational keys. The remote control device may alternatively detect a selection of an input key other than one of the four directional navigation keys and a select key, and may exit the numeric input mode in response to such a selection. The remote control device may further change the numeric input mode to the directional navigation input mode for further navigation within the user interface of the television. Subsequent key presses of the directional navigation keys may be detected and the remote control device may send navigation commands to the television during the directional navigation input mode.

The subject matter described herein may be performed in real time. For purposes of the present description, the term “real time” shall include what is commonly termed “near real time”—generally meaning any time frame of sufficiently short duration as to provide reasonable response time for on demand information processing acceptable to a user of the subject matter described (e.g., within a few seconds or less than ten seconds or so in certain systems). These terms, while difficult to precisely define are well understood by those skilled in the art. It is further understood that the subject matter described herein may be performed in real time and/or near real time.

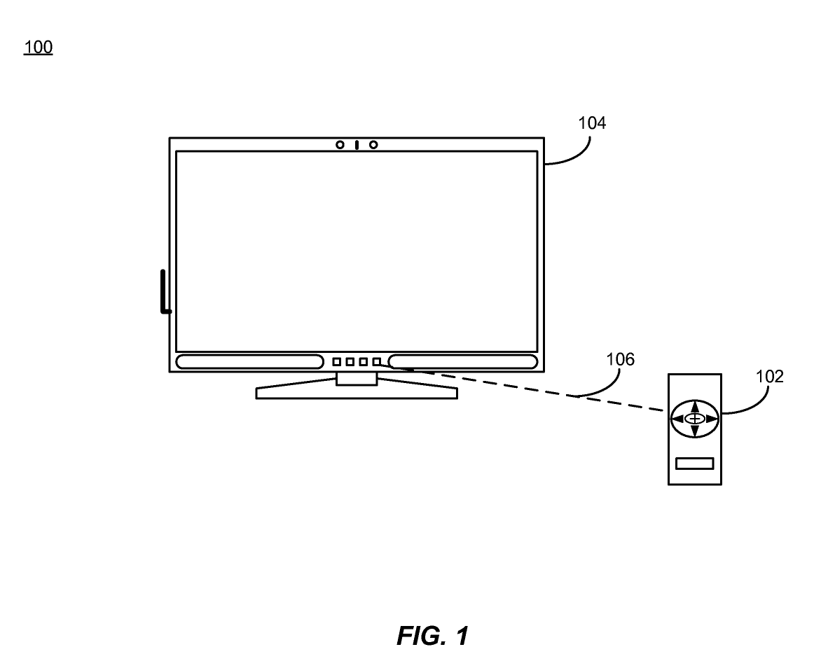

Turning now to FIG. 1, FIG. 1 is a block diagram of an example of an implementation of a system 100 that provides numeric input using navigation keys. A remote controller device 102 interacts with and controls a television receiver device 104 via infrared signaling 106. While the present example utilizes infrared signaling 106 for purposes of example, it is understood that wireless or other interfaces are possible for signaling between the remote controller device 102 and the television receiver device 104, and all are considered within the scope of the present subject matter. As described above, it should be noted that television receiver devices may include devices, such as for example, a television set, a set-top box (STB), a set back box, a receiver card, or other device for receiving and decoding television signals. The examples herein may utilize the term “television” for ease of reference. However, it is understood that the term “television” may include any television receiver device.

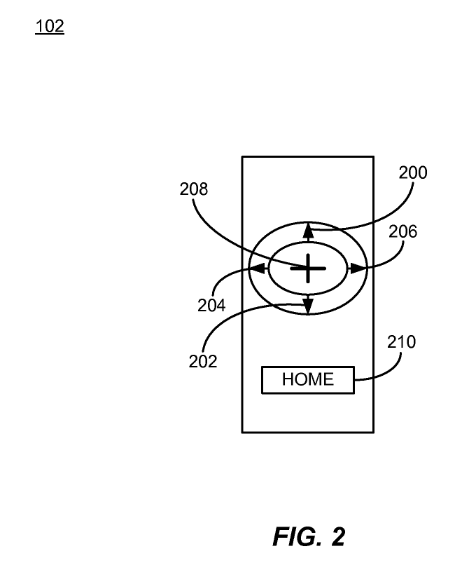

FIG. 2 is a detailed diagram of an example of an implementation of the remote controller device 102 that provides numeric input using navigation keys. The remote controller device 102 includes an up directional navigation key 200, a down directional navigation key 202, a left directional navigation key 204, and a right directional navigation key 206. The remote controller device 102 also includes a select key 208. A home key 210 is also illustrated.

It should be noted that the directional navigation keys 200 through 206 and the select key 208 are formed within a single mechanical key with different contacts/key press sensors for each of the respective key press locations under the single mechanical key. Alternatively, the respective keys may be implemented as individual mechanical keys or some other combination of mechanical interconnectivity that may be utilized as appropriate for a given implementation. The directional navigation keys 200 through 206 may be utilized, as described above and in more detail below, for both navigation and numeric entry within numeric input fields of a user interface of the television receiver device 104. The select key 208 provides a separate contact/key press sensor for an “enter” command or other commands as appropriate for a given implementation. The home key 210 may be utilized to cause the remote controller device 102 to return to a default processing mode and/or to cause a television user interface to return to a “home” menu.

As such, the remote controller device 102 includes a reduced number of components relative to conventional remote controls and may provide improved reliability as a result. Additionally, a user may memorize key press sequences for rapid navigation and numeric input entry.

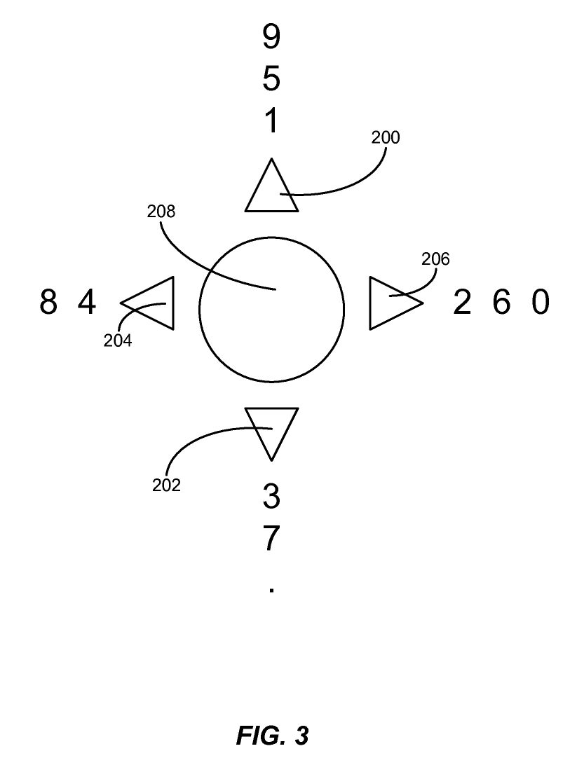

FIG. 3 is a diagram of an example of an implementation of numeric key assignments for the remote controller device 102 that may be used to provide numeric input using navigation keys. Each of the directional navigation keys 200 through 206 and the select key 208 are illustrated. The example key assignment within FIG. 3 is shown to begin with the up directional navigation key 200 and to proceed in a clockwise direction to iteratively/sequentially assign characters representing each of the numerals zero (0) through nine (9) and the decimal point clockwise from a first one of the four directional navigation keys. For purposes of the present example, it is assumed that the character representing a zero (0) is assigned after the character representing the nine (9), and that the character representing the decimal point is assigned after the zero (0). However, this should not be considered limiting because any sequence of assignment of the respective characters to the directional navigation keys 200 through 206 may be utilized as appropriate for a given implementation.

For purposes of the present example, the character position relative to distance from the respective key represents the number of detected key presses of the respective directional navigation key to cause the respective numeral character to be sent to the television receiver device 104 for use in association with the user interface of the television receiver device 104. As such, a single key press of the up directional navigation key 200 results in a character representing a numeral one (1) being selected. A second key press of the up directional navigation key 200 results in a character representing a numeral five (5) being selected. A third key press of the up directional navigation key 200 results in a character representing a numeral nine (9) being selected.

Similarly, a single key press of the right directional navigation key 206 results in a character representing a numeral two (2) being selected, a second key press results in a character representing a numeral six (6) being selected, and a third key press results in a character representing a numeral zero (0) being selected. For the down directional navigation key 202, characters representing the numeral three (3), the numeral seven (7), and the decimal point are selected in response to one, two, and three detected presses of the down directional navigation key 202, respectively. For the left directional navigation key 204, characters representing the numeral four (4) and the numeral eight (8) are selected in response to one and two detected presses of the left directional navigation key 204, respectively. There is no assignment of a character to a third press of the left directional navigation key 204 within the present example.

As described in more detail below, the respective characters may be sent to the television receiver device 104 in response to each key press to provide the user with visual feedback via the user interface of the television receiver device 104. Alternatively, key presses may be processed until a particular selected character is determined by the remote controller device 102 prior to sending the selected character to the television receiver device 104. This option of when to send numeric characters to the television receiver device 104 may further be configurable and selectable by a user, such that a user that wishes to rapidly enter numeric sequences with memorized steps of key presses may do so without using the visual feedback. Alternatively, users that desire the visual feedback may select sending each numeric character to the television receiver device 104 for display. It should however be noted that certain numeric entry fields, such as passwords or other fields, may utilize asterisks or other wildcard characters to avoid display of the respective numeric characters. In such an implementation, the configuration for sending characters to the television receiver device 104 after a particular selected character is determined by the remote controller device 102 may provide the user with feedback that is more consistent with the data entry goal of the respective numeric input field. Many possibilities exist for determining when and how often to transmit numeric characters to the television receiver device 104 for display and all are considered within the scope of the present subject matter.

Accordingly, FIG. 3 shows one example of characters representing each of numerals zero (0) through nine (9) and a decimal point each assigned to one of four directional navigation keys 200 through 206. Further, each character assigned to each respective directional navigation key is further assigned to a different number of presses of the respective directional navigation key. Many other assignment possibilities exist and all are considered within the scope of the present subject matter.

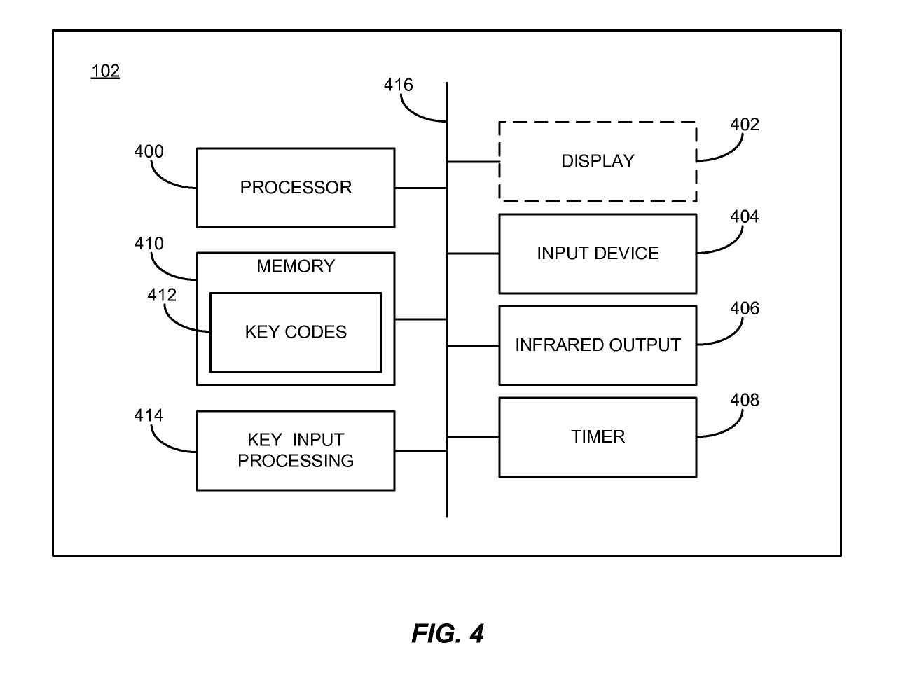

FIG. 4 is a block diagram of an example of an implementation of the remote controller device 102 that provides numeric input using navigation keys. A processor 400 provides computer instruction execution, computation, and other capabilities within the remote controller device 102. A display device 402 provides visual and/or other information to a user of the remote controller device 102. The display device 402 may include any type of display device, such as a cathode ray tube (CRT), liquid crystal display (LCD), light emitting diode (LED), electronic ink displays or other display element or panel. It should be noted that the display device 402 is illustrated with a dashed-line representation within FIG. 4 to indicate that it may be an optional component for the remote controller device 102.

An input device 404 provides input capabilities for processing input keys, including directional navigational keys, that form a portion of the remote controller device 102, as described above in association with FIG. 2. The input device 404 provides key press debounce processing and other functionality to identify which user interface keys of the remote controller device 102 have been pressed and to filter presses to remove bounced key hits so that each key press reported may be utilized without duplicates that were not intended by a user of the remote controller device 102.

An infrared output device 406 provides output capabilities for control of devices, such as the television receiver device 104. As described above, it is understood that wireless or other interfaces are possible for signaling between the remote controller device 102 and the television receiver device 104. As such, the infrared output device 406 has been selected for purposes of example.

A timer module 408 is illustrated and used to determine timing information, such as time measurements associated with inter-key press times and times from a last press of any given directional navigation key, as described above and in more detail below. The remote controller device 102 may utilize information derived from the timer module 408 for information processing activities, such as the numeric input using navigation keys described herein.

A memory 410 includes a key code storage area 412 that stores key codes for input processing. The key code storage area 412 stores assigned characters representing each of numerals zero (0) through nine (9) and a decimal point to one of four directional navigation keys, as described above in association with FIG. 3. Each character assigned to each respective directional navigation key is further assigned to a different number of presses of the respective directional navigation key, and this assignment of the different number of presses that represent each assigned character is also stored within the key code storage area 412.

It is understood that the memory 410 may include any combination of volatile and non-volatile memory suitable for the intended purpose, distributed or localized as appropriate, and may include other memory segments not illustrated within the present example for ease of illustration purposes. For example, the memory 410 may include a code storage area, an operating system storage area, a code execution area, and a data area without departure from the scope of the present subject matter.

A key input processing module 414 is also illustrated. The key input processing module 414 provides television control functionality and higher-level key input processing for the remote controller device 102 in response to filtered key inputs received from the input device 404, as described above and in more detail below. The key input processing module 414 implements the automated numeric input using navigation keys of the remote controller device 102.

It should be noted that the modules described above in association with the remote controller device 102 are illustrated as component-level modules for ease of illustration and description purposes. It is also understood that these modules include any hardware, programmed processor(s), and memory used to carry out the respective functions of these modules as described above and in more detail below. For example, the respective modules may include additional controller circuitry in the form of application specific integrated circuits (ASICs), processors, antennas, and/or discrete integrated circuits and components for performing electrical control activities. Additionally, the modules may include interrupt-level, stack-level, and application-level modules as appropriate. Furthermore, the modules may include any memory components used for storage, execution, and data processing by these modules for performing the respective processing activities. The modules may also form a portion of other circuitry described below without departure from the scope of the present subject matter.

It should also be noted that the key input processing module 414 may form a portion of other circuitry described without departure from the scope of the present subject matter. Further, the key input processing module 414 may alternatively be implemented as an application stored within the memory 410. In such an implementation, the key input processing module 414 may include instructions executed by the processor 400 for performing the functionality described herein. The processor 400 may execute these instructions to provide the processing capabilities described above and in more detail below for the remote controller device 102. The key input processing module 414 may form a portion of an interrupt service routine (ISR), a portion of an operating system, a portion of a browser application, or a portion of a separate application without departure from the scope of the present subject matter.

The processor 400, the display device 402, the input device 404, the infrared output device 406, the timer module 408, the memory 410, and the key input processing module 414 are interconnected via one or more interconnections shown as interconnection 416 for ease of illustration. The interconnection 416 may include a system bus, a network, or any other interconnection capable of providing the respective components with suitable interconnection for the respective purpose.

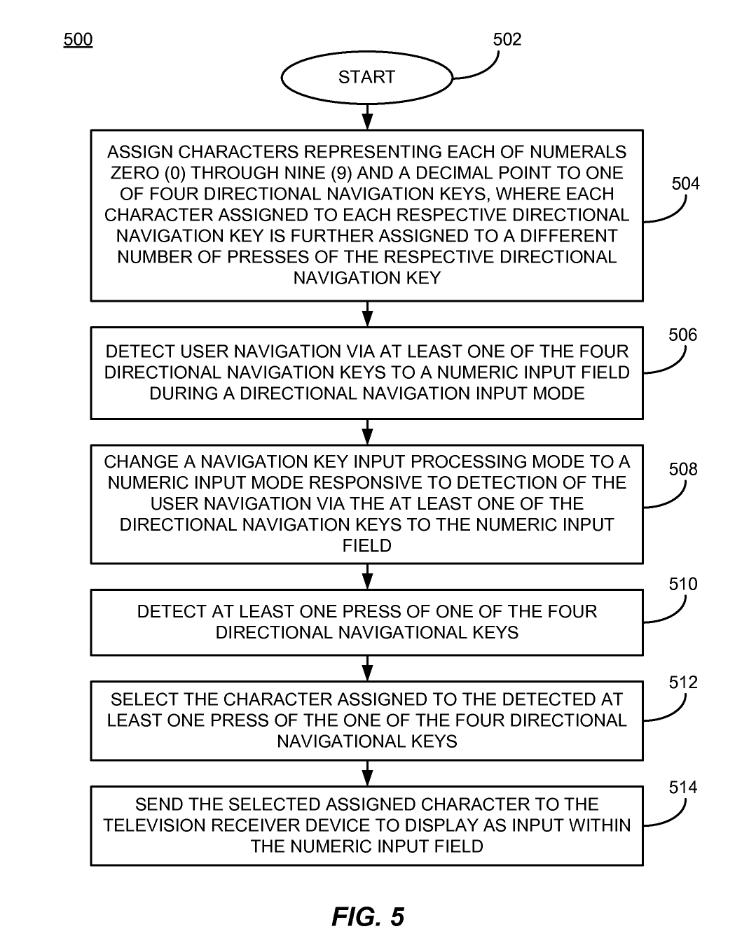

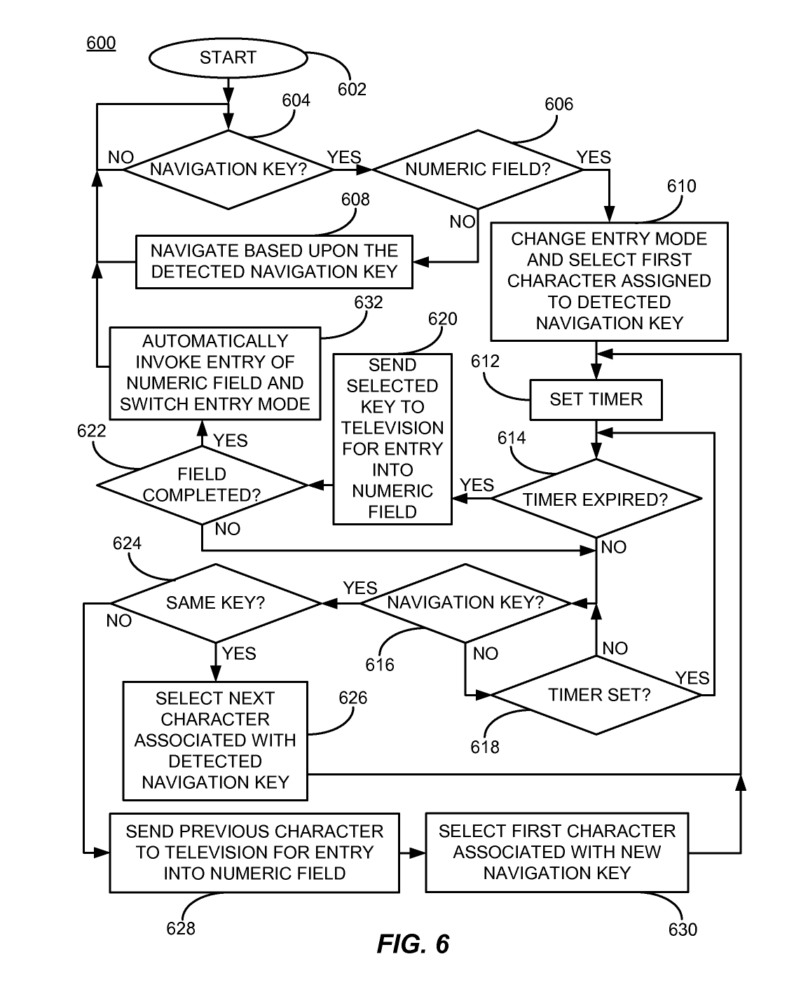

FIG. 5 through FIG. 6 below describe example processes that may be executed by devices, such as the remote controller device 102, to perform the automated numeric input using navigation keys associated with the present subject matter. Many other variations on the example processes are possible and all are considered within the scope of the present subject matter. The example processes may be performed by modules, such as the key input processing module 414 and/or executed by the processor 400, associated with such devices. It should be noted that time out procedures and other error control procedures are not illustrated within the example processes described below for ease of illustration purposes. However, it is understood that all such procedures are considered to be within the scope of the present subject matter.

FIG. 5 is a flow chart of an example of an implementation of a process 500 that provides automated numeric input using navigation keys. The process 500 along with the other processes described below may be executed by a device, such as the remote controller device 102. The process 500 starts at 502. At block 504, the process 500 assigns characters representing each of numerals zero (0) through nine (9) and a decimal point to one of four directional navigation keys, where each character assigned to each respective directional navigation key is further assigned to a different number of presses of the respective directional navigation key. At block 506, the process 500 detects user navigation via at least one of the four directional navigation keys to a numeric input field during a directional navigation input mode. At block 508, the process 500 changes a navigation key input processing mode to a numeric input mode responsive to detection of the user navigation via the at least one of the directional navigation keys to the numeric input field. At block 510, the process 500 detects at least one press of one of the four directional navigational keys. At block 512, the process 500 selects the character assigned to the detected at least one press of the one of the four directional navigational keys. At block 514, the process 500 sends the selected assigned character to the television receiver device to display as input within the numeric input field.

FIG. 6 is a flow chart of another example of an implementation of a process 600 that provides automated numeric input using navigation keys. It should be noted that all navigational and numeric input for the process 600 is entered using the directional navigational keys, such as the directional navigation keys 200 through 206 described above in association with FIG. 2 and FIG. 3. It is further assumed that an initial navigation key input processing mode for the process 600 is a directional navigation input mode.

The process 600 starts at 602. At decision point 604, the process 600 makes a determination as to whether user entry of a navigation key has been detected. In response to detecting user entry of a navigation key, the process 600 makes a determination at decision point 606 as to whether user navigation via at least one of the directional navigation keys to a numeric input field has been detected during the directional navigation input mode. It is understood that the process 600 may be preconfigured with knowledge of available menu structures for the television receiver device 104 and that the process 600 may track navigation using the directional navigation keys and automatically determine navigation to a numeric input field. Alternatively, the television receiver device 104 may process navigation inputs and notify the remote controller device 102 that a numeric input field has been entered. In the latter implementation, the remote controller device 102 may be modified with any form of communication module appropriate for receiving notifications and indications from the television receiver device 104. Examples of communication modules include infrared, wireless, among others.

In response to determining that a user navigation via at least one of the directional navigation keys to a numeric input field has not been detected at decision point 606, the process 600 navigates based upon the detected directional navigation key at block 608 and returns to decision point 604 to process additional navigational keys. In response to determining that a user navigation via at least one of the directional navigation keys to a numeric input field has been detected at decision point 606, the process 600 changes a navigation key input processing mode to a numeric input mode and selects the first character assigned a first press of the detected directional navigational key at block 610.

At block 612, the process 600 sets a timer, such as the timer module 408, to begin measurement of inter-key press timing and lag from last-detected key presses. As described above, processing may be performed to debounce input keys to avoid multiple registration of single user key presses. This processing is omitted from the process 600 for brevity. However, it is understood that key debounce may be operative on the order of fifty milliseconds (50 ms), or otherwise as appropriate for a given implementation. As also described above, timer expiration may be utilized for automated completion of entry for a particular numeric character or entry of all numeric characters for a given numeric input field. As such, the timer may be utilized for this processing as well.

At decision point 614, the process 600 makes a determination as to whether the timer has expired. This determination may include determining that an inter-key press time threshold has expired. This inter-key press time threshold may be based upon a pre-configured or user configurable sequential key press timing value, and may further be distinguished from a debounce time interval. Further, the process 600 may determine a time between presses of the detected directional navigation key where multiple key presses are detected and may determine that a configured maximum time threshold for sequential numeric key input presses has expired.

Iterative processing relative to an affirmative determination at decision point 614 is illustrated within FIG. 6 and will be described in more detail below. As such, in response to determining that the timer has not expired, the process 600 makes a determination at decision point 616 as to whether another navigation key press has been detected. It is understood that detection of another navigation key press may include detection of another user key press of the same directional navigation key or detection of a user key press of a different directional navigation key.

In response to determining that another navigation key press has not been detected at decision point 616, the process 600 makes a determination as to whether the timer is currently set at decision point 618. In response to determining that the timer is set at decision point 618, the process 600 returns to decision point 614 and iterates as described above to await expiration of the timer. In response to determining that the timer is not set at decision point 618, the process 600 returns to decision point 616 to await detection of another key press. As such, the process 600 iteratively checks for timer expiration and detection of additional key presses. As described above, timeouts and other processing may be associated with the process 600 without departure from the scope of the present subject matter.

Returning to the description of decision point 614, in response to determining at decision point 614 that the timer has expired, the process 600 sends the selected assigned character to the television receiver device 104 as input within the numeric input field at block 620. Sending the selected assigned character to the television receiver device 104 may include selecting the character assigned to the detected key press of the detected directional navigational keys in response to determining that the configured maximum time threshold for sequential numeric key input presses has expired. The process 600 may further instruct the television receiver device 104 to move a numeric entry prompt to a new numeric character position within the numeric input field. It is understood that the television receiver device 104 will display the character sent to it in response to receipt of the character.

Additionally, as described above, each character associated with each of the quantity of key presses may be sent to the television receiver device 104 for display to facilitate visual user feedback, as appropriate for a given implementation. As such, the timer expiration value may be chosen to cause each assigned key character to be sent to the television receiver device 104, or the process 600 may be configured to automatically send each assigned key character to the television receiver device 104, as appropriate for a given implementation.

At decision point 622, the process 600 makes a determination as to whether entry for the numeric input field has been completed (e.g., all numeric characters entered). The determination as to whether entry for the numeric input field has been completed may include automated determination based upon pre-configured knowledge of numeric input field widths or detection of a user selection of a select key function, such as the directional navigation keys 200 through 206 described above, as appropriate for a given implementation.

Iterative processing for an affirmative determination at decision point 622 will be described in more detail below. As such, in response to determining that entry for the numeric input field has not been completed at decision point 622, the process 600 returns to decision point 616 and iterates as described above to detect additional directional navigational key presses.

Returning to the description of decision point 616, in response to determining that an additional navigation key press has been detected, the process 600 makes a determination at decision point 624 as to whether the detected additional navigational key is the same key previously detected (e.g., that the user has pressed the same key again). In response to determining that the detected additional navigational key is the same key previously detected, the process 600 selects the next/new character/number associated with the detected directional navigation key at block 626 at returns to block 612 to set a new timer and iterates as described above. As such, the process 600 may determine a quantity of presses of one of the four directional navigational keys and select the character assigned to the detected quantity of presses of the one of the four directional navigational keys.

In response to determining at decision point 624 that the detected additional navigational key is a different directional navigation key, the process 600 sends the previously selected assigned character for the previously-detected directional navigation key to the television receiver device 104 as input within the numeric input field at block 628. The process 600 may further send an instruction to the television to finalize input for a current numeric character position using the sent numeric character (or the last sent assigned character where each character is sent to the television as selected) and to move a numeric entry prompt to a new numeric character position. At block 630, the process 600 selects the first character assigned a first press of the detected different directional navigational key and returns to block 612 to set a new timer and iterates as described above.

Returning to the description of decision point 622, in response to determining that entry for the numeric input field has been completed, the process 600 automatically invokes entry of the numeric field and changes the navigation key input processing mode back to the directional navigation input mode at block 632 and iterates as described above. Invoking entry of the numeric field may include instructing the television receiver device 104 to process the displayed character within the numeric input field.

As such, the process 600 operates to change between a directional navigation input mode and a numeric input mode for the same directional navigation keys based upon detection of a numeric input field. The process 600 iteratively selects numbers/characters assigned to directional navigation keys in response to detection of consecutive key presses. The process 600 sends selected assigned key characters to the television receiver device 104 for processing and automatically invokes entry of the numeric field in response to determining that entry of numeric characters into the numeric field is completed. It should be understood that the process 600 may be modified to respond to a select key, such as the select key 208 described above, to invoke an enter operation on the numeric input field without departure from the scope of the present subject matter.

Thus, in accord with certain implementations, a method of receiving numeric input via a television receiver device user interface navigation controller involves assigning characters representing each of numerals zero (0) through nine (9) and a decimal point to one of four directional navigation keys, where each character assigned to each respective directional navigation key is further assigned to a different number of presses of the respective directional navigation key and each character is iteratively/sequentially assigned clockwise from a first one of the four directional navigation keys; detecting user navigation via at least one of the four directional navigation keys to a numeric input field during a directional navigation input mode; changing a navigation key input processing mode to a numeric input mode responsive to detection of the user navigation via the at least one of the directional navigation keys to the numeric input field; detecting at least one press of one of the four directional navigational keys; determining a quantity of presses of the one of the four directional navigational keys; selecting the character assigned to the determined quantity of presses of the one of the four directional navigational keys; sending the selected assigned character to the television receiver device to display as input within the numeric input field; determining that an inter-key press time threshold has expired; sending an instruction to the television receiver device to finalize input for a current numeric character position using the selected assigned character sent to the television receiver device; sending an instruction to the television receiver device to move a numeric entry prompt to a new numeric character position; detecting user selection of a select key, where the select key is integrated with the four directional navigational keys within a single mechanical key; instructing the television receiver device to process the displayed character within the numeric input field; and changing the navigation key input processing mode to the directional navigation input mode.

In certain implementations, a method of receiving numeric input via a television receiver device user interface navigation controller involves assigning characters representing each of numerals zero (0) through nine (9) and a decimal point to one of four directional navigation keys, where each character assigned to each respective directional navigation key is further assigned to a different number of presses of the respective directional navigation key; detecting user navigation via at least one of the four directional navigation keys to a numeric input field during a directional navigation input mode; changing a navigation key input processing mode to a numeric input mode responsive to detection of the user navigation via the at least one of the directional navigation keys to the numeric input field; detecting at least one press of one of the four directional navigational keys; selecting the character assigned to the detected at least one press of the one of the four directional navigational keys; and sending the selected assigned character to the television receiver device to display as input within the numeric input field.

In certain implementations, the method of receiving numeric input via a television receiver device user interface navigation controller further involves iteratively detecting further selections of at least one press of an additional one of the four directional navigational keys; selecting characters assigned to the further selections of the at least one press of the additional one of the four directional navigational keys; and sending the further selected assigned characters to the television receiver device as input within the numeric input field. In certain implementations, the method further involves detecting user selection of a select key;

instructing the television receiver device to process the displayed character within the numeric input field; and changing the navigation key input processing mode to the directional navigation input mode. In certain implementations, the select key is integrated with the four directional navigational keys within a single mechanical key. In certain implementations, the method of assigning the characters representing each of the numerals zero (0) through nine (9) and the decimal point to one of four directional navigation keys involves iteratively/sequentially assigning the characters representing each of the numerals zero (0) through nine (9) and the decimal point clockwise from a first one of the four directional navigation keys. In certain implementations, the method of selecting the character assigned to the detected at least one press of the one of the four directional navigational keys involves determining a quantity of presses of the one of the four directional navigational keys; and selecting the character assigned to the detected quantity of presses of the one of the four directional navigational keys. In certain implementations, the method of selecting the character assigned to the detected at least one press of the one of the four directional navigational keys involves selecting the character assigned to each of the at least one press of the one of the four navigational keys; and the method further involves sending each selected assigned character to the television receiver device to display as input within the numeric input field. In certain implementations, the method further involves determining that an inter-key press time threshold has expired; sending an instruction to the television receiver device to finalize input for a current numeric character position using a last sent assigned character; and sending an instruction to the television receiver device to move a numeric entry prompt to a new numeric character position. In certain implementations, the method further involves detecting at least one press of a different one of the four directional navigational keys; sending an instruction to the television receiver device to finalize input for a current numeric character position using a last sent assigned character; sending an instruction to the television receiver device to move a numeric entry prompt to a new numeric character position; determining a quantity of presses of the different one of the four directional navigational keys; selecting the character assigned to the detected quantity of presses of the different one of the four directional navigational keys; and sending the selected assigned character to the television receiver device to display as input within the new numeric character position of the numeric input field. In certain implementations, the method further involves determining a time between presses of the one of the four directional navigation keys; determining that a configured maximum time threshold for sequential numeric key input presses has expired; and the method of selecting the character assigned to the detected at least one press of the one of the four directional navigational keys involves selecting the character assigned to the detected at least one press of the one of the four directional navigational keys in response to determining that the configured maximum time threshold for sequential numeric key input presses has expired.

In another implementation, a computer readable storage medium may store instructions which, when executed on one or more programmed processors, carry out a process of assigning characters representing each of numerals zero (0) through nine (9) and a decimal point to one of four directional navigation keys, where each character assigned to each respective directional navigation key is further assigned to a different number of presses of the respective directional navigation key; detecting user navigation via at least one of the four directional navigation keys to a numeric input field during a directional navigation input mode; changing a navigation key input processing mode to a numeric input mode responsive to detection of the user navigation via the at least one of the directional navigation keys to the numeric input field; detecting at least one press of one of the four directional navigational keys; selecting the character assigned to the detected at least one press of the one of the four directional navigational keys; and sending the selected assigned character to the television receiver device to display as input within the numeric input field.

A remote controller device, consistent with certain implementations, has an input device including four directional navigational keys and a processor programmed to assign characters representing each of numerals zero (0) through nine (9) and a decimal point to one of the four directional navigation keys, where each character assigned to each respective directional navigation key is further assigned to a different number of presses of the respective directional navigation key; detect user navigation via at least one of the four directional navigation keys to a numeric input field during a directional navigation input mode; change a navigation key input processing mode to a numeric input mode responsive to detection of the user navigation via the at least one of the directional navigation keys to the numeric input field; detect at least one press of one of the four directional navigational keys; select the character assigned to the detected at least one press of the one of the four directional navigational keys; and send the selected assigned character to the television receiver device to display as input within the numeric input field.

In certain implementations, the processor is further programmed to iteratively detect further selections of at least one press of an additional one of the four directional navigational keys; select characters assigned to the further selections of the at least one press of the additional one of the four directional navigational keys; and send the further selected assigned characters to the television receiver device as input within the numeric input field. In certain implementations, the input device further includes a select key and the processor is further programmed to detect user selection of the select key; instruct the television receiver device to process the displayed character within the numeric input field; and change the navigation key input processing mode to the directional navigation input mode. In certain implementations, the select key is integrated with the four directional navigational keys within a single mechanical key of the input device. In certain implementations, in being programmed to assign the characters representing each of the numerals zero (0) through nine (9) and the decimal point to one of four directional navigation keys, the processor is programmed to iteratively/sequentially assign the characters representing each of the numerals zero (0) through nine (9) and the decimal point clockwise from a first one of the four directional navigation keys. In certain implementations, in being programmed to select the character assigned to the detected at least one press of the one of the four directional navigational keys, the processor is programmed to determine a quantity of presses of the one of the four directional navigational keys; and select the character assigned to the detected quantity of presses of the one of the four directional navigational keys. In certain implementations, in being programmed to select the character assigned to the detected at least one press of the one of the four directional navigational keys, the processor is programmed to select the character assigned to each of the at least one press of the one of the four navigational keys; and send each selected assigned character to the television receiver device to display as input within the numeric input field. In certain implementations, the processor is further programmed to determine that an inter-key press time threshold has expired; send an instruction to the television receiver device to finalize input for a current numeric character position using a last sent assigned character; and send an instruction to the television receiver device to move a numeric entry prompt to a new numeric character position. In certain implementations, the processor is further programmed to detect at least one press of a different one of the four directional navigational keys; send an instruction to the television receiver device to finalize input for a current numeric character position using a last sent assigned character; send an instruction to the television receiver device to move a numeric entry prompt to a new numeric character position; determine a quantity of presses of the different one of the four directional navigational keys; select the character assigned to the detected quantity of presses of the different one of the four directional navigational keys; and send the selected assigned character to the television receiver device to display as input within the new numeric character position of the numeric input field. In certain implementations, the processor is further programmed to determine a time between presses of the one of the four directional navigation keys; determine that a configured maximum time threshold for sequential numeric key input presses has expired; and, in being programmed to select the character assigned to the detected at least one press of the one of the four directional navigational keys, the processor is programmed to select the character assigned to the detected at least one press of the one of the four directional navigational keys in response to determining that the configured maximum time threshold for sequential numeric key input presses has expired.

While certain embodiments herein were described in conjunction with specific circuitry that carries out the functions described, other embodiments are contemplated in which the circuit functions are carried out using equivalent elements executed on one or more programmed processors. General purpose computers, microprocessor based computers, micro-controllers, optical computers, analog computers, dedicated processors, application specific circuits and/or dedicated hard wired logic and analog circuitry may be used to construct alternative equivalent embodiments. Other embodiments could be implemented using hardware component equivalents such as special purpose hardware, dedicated processors or combinations thereof.

Certain embodiments may be implemented using one or more programmed processors executing programming instructions that in certain instances are broadly described above in flow chart form that can be stored on any suitable electronic or computer readable storage medium (such as, for example, disc storage, Read Only Memory (ROM) devices, Random Access Memory (RAM) devices, network memory devices, optical storage elements, magnetic storage elements, magneto-optical storage elements, flash memory, core memory and/or other equivalent volatile and non-volatile storage technologies). However, those skilled in the art will appreciate, upon consideration of the present teaching, that the processes described above can be implemented in any number of variations and in many suitable programming languages without departing from embodiments of the present invention. For example, the order of certain operations carried out can often be varied, additional operations can be added or operations can be deleted without departing from certain embodiments of the invention. Error trapping can be added and/or enhanced and variations can be made in user interface and information presentation without departing from certain embodiments of the present invention. Such variations are contemplated and considered equivalent.

While certain illustrative embodiments have been described, it is evident that many alternatives, modifications, permutations and variations will become apparent to those skilled in the art in light of the foregoing description.

What is claimed is:

1. A method of receiving numeric input via a television receiver device user interface navigation controller, comprising:
assigning characters representing each of numerals zero (0) through nine (9) and a decimal point to one of four directional navigation keys, where each character assigned to each respective directional navigation key is further assigned to a different number of presses of the respective directional navigation key and each character is iteratively/sequentially assigned clockwise from a first one of the four directional navigation keys;
detecting user navigation via at least one of the four directional navigation keys to a numeric input field during a directional navigation input mode;
changing a navigation key input processing mode to a numeric input mode responsive to detection of the user navigation via the at least one of the directional navigation keys to the numeric input field;
detecting at least one press of one of the four directional navigational keys;
determining a quantity of presses of the one of the four directional navigational keys;
selecting the character assigned to the determined quantity of presses of the one of the four directional navigational keys;
sending the selected assigned character to the television receiver device to display as input within the numeric input field;
determining that an inter-key press time threshold has expired;
sending an instruction to the television receiver device to finalize input for a current numeric character position using the selected assigned character sent to the television receiver device;
sending an instruction to the television receiver device to move a numeric entry prompt to a new numeric character position;
detecting user selection of a select key, where the select key is integrated with the four directional navigational keys within a single mechanical key;
instructing the television receiver device to process the displayed character within the numeric input field; and
changing the navigation key input processing mode to the directional navigation input mode.

2. A method of receiving numeric input via a television receiver device user interface navigation controller, comprising:
assigning characters representing each of numerals zero (0) through nine (9) and a decimal point to one of four directional navigation keys, where each character assigned to each respective directional navigation key is further assigned to a different number of presses of the respective directional navigation key;
detecting user navigation via at least one of the four directional navigation keys to a numeric input field during a directional navigation input mode;
changing a navigation key input processing mode to a numeric input mode responsive to detection of the user navigation via the at least one of the directional navigation keys to the numeric input field;
detecting at least one press of one of the four directional navigational keys;
selecting the character assigned to the detected at least one press of the one of the four directional navigational keys; and
sending the selected assigned character to the television receiver device to display as input within the numeric input field.

3. The method according to claim 2, further comprising:
iteratively detecting further selections of at least one press of an additional one of the four directional navigational keys;
selecting characters assigned to the further selections of the at least one press of the additional one of the four directional navigational keys; and
sending the further selected assigned characters to the television receiver device as input within the numeric input field.

4. The method according to claim 2, further comprising:
detecting user selection of a select key;
instructing the television receiver device to process the displayed character within the numeric input field; and
changing the navigation key input processing mode to the directional navigation input mode.

5. The method according to claim 4, where the select key is integrated with the four directional navigational keys within a single mechanical key.

6. The method according to claim 2, where assigning the characters representing each of the numerals zero (0) through nine (9) and the decimal point to one of four directional navigation keys comprises iteratively/sequentially assigning the characters representing each of the numerals zero (0) through nine (9) and the decimal point clockwise from a first one of the four directional navigation keys.

7. The method according to claim 2, where selecting the character assigned to the detected at least one press of the one of the four directional navigational keys comprises:
determining a quantity of presses of the one of the four directional navigational keys; and
selecting the character assigned to the detected quantity of presses of the one of the four directional navigational keys.

8. The method according to claim 2, where:
selecting the character assigned to the detected at least one press of the one of the four directional navigational keys comprises selecting the character assigned to each of the at least one press of the one of the four navigational keys; and
sending each selected assigned character to the television receiver device to display as input within the numeric input field.

9. The method according to claim 8, further comprising:
determining that an inter-key press time threshold has expired;
sending an instruction to the television receiver device to finalize input for a current numeric character position using a last sent assigned character; and
sending an instruction to the television receiver device to move a numeric entry prompt to a new numeric character position.

10. The method according to claim 8, further comprising:
detecting at least one press of a different one of the four directional navigational keys;
sending an instruction to the television receiver device to finalize input for a current numeric character position using a last sent assigned character;
sending an instruction to the television receiver device to move a numeric entry prompt to a new numeric character position;
determining a quantity of presses of the different one of the four directional navigational keys;
selecting the character assigned to the detected quantity of presses of the different one of the four directional navigational keys; and
sending the selected assigned character to the television receiver device to display as input within the new numeric character position of the numeric input field.

11. The method according to claim 2, further comprising:
determining a time between presses of the one of the four directional navigation keys;
determining that a configured maximum time threshold for sequential numeric key input presses has expired; and
where selecting the character assigned to the detected at least one press of the one of the four directional navigational keys comprises selecting the character assigned to the detected at least one press of the one of the four directional navigational keys in response to determining that the configured maximum time threshold for sequential numeric key input presses has expired.

12. A computer readable storage medium storing instructions which, when executed on one or more programmed processors, carry out a method according to claim 2.

13. A remote controller device, comprising:
an input device comprising four directional navigational keys; and
a processor programmed to:
assign characters representing each of numerals zero (0) through nine (9) and a decimal point to one of the four directional navigation keys, where each character assigned to each respective directional navigation key is further assigned to a different number of presses of the respective directional navigation key;
detect user navigation via at least one of the four directional navigation keys to a numeric input field during a directional navigation input mode;
change a navigation key input processing mode to a numeric input mode responsive to detection of the user navigation via the at least one of the directional navigation keys to the numeric input field;
detect at least one press of one of the four directional navigational keys;
select the character assigned to the detected at least one press of the one of the four directional navigational keys; and
send the selected assigned character to the television receiver device to display as input within the numeric input field.

14. The remote controller device according to claim 13, where the processor is further programmed to:
iteratively detect further selections of at least one press of an additional one of the four directional navigational keys;
select characters assigned to the further selections of the at least one press of the additional one of the four directional navigational keys; and
send the further selected assigned characters to the television receiver device as input within the numeric input field.

15. The remote controller device according to claim 13, where the input device further comprises a select key and where the processor is further programmed to:
detect user selection of the select key;
instruct the television receiver device to process the displayed character within the numeric input field; and
change the navigation key input processing mode to the directional navigation input mode.

16. The remote controller device according to claim 15, where the select key is integrated with the four directional navigational keys within a single mechanical key of the input device.

17. The remote controller device according to claim 13, where, in being programmed to assign the characters representing each of the numerals zero (0) through nine (9) and the decimal point to one of four directional navigation keys, the processor is programmed to iteratively/sequentially assign the characters representing each of the numerals zero (0) through nine (9) and the decimal point clockwise from a first one of the four directional navigation keys.

18. The remote controller device according to claim 13, where, in being programmed to select the character assigned to the detected at least one press of the one of the four directional navigational keys, the processor is programmed to:
determine a quantity of presses of the one of the four directional navigational keys; and
select the character assigned to the detected quantity of presses of the one of the four directional navigational keys.

19. The remote controller device according to claim 13, where, in being programmed to select the character assigned to the detected at least one press of the one of the four directional navigational keys, the processor is programmed to:
select the character assigned to each of the at least one press of the one of the four navigational keys; and
send each selected assigned character to the television receiver device to display as input within the numeric input field.

20. The remote controller device according to claim 19, where the processor is further programmed to:
determine that an inter-key press time threshold has expired;
send an instruction to the television receiver device to finalize input for a current numeric character position using a last sent assigned character; and
send an instruction to the television receiver device to move a numeric entry prompt to a new numeric character position.

21. The remote controller device according to claim 19, where the processor is further programmed to:
detect at least one press of a different one of the four directional navigational keys;
send an instruction to the television receiver device to finalize input for a current numeric character position using a last sent assigned character;
send an instruction to the television receiver device to move a numeric entry prompt to a new numeric character position;
determine a quantity of presses of the different one of the four directional navigational keys;
select the character assigned to the detected quantity of presses of the different one of the four directional navigational keys; and
send the selected assigned character to the television receiver device to display as input within the new numeric character position of the numeric input field.

22. The remote controller device according to claim 13, where the processor is further programmed to:
determine a time between presses of the one of the four directional navigation keys;
determine that a configured maximum time threshold for sequential numeric key input presses has expired; and
where, in being programmed to select the character assigned to the detected at least one press of the one of the four directional navigational keys, the processor is programmed to select the character assigned to the detected at least one press of the one of the four directional navigational keys in response to determining that the configured maximum time threshold for sequential numeric key input presses has expired.
